(19) United States
(12) Patent Application Publication
(10) Pub. No.: US 2024/0239532 A1
(43) Pub. Date: Jul. 18, 2024

(54) TECHNIQUES FOR LAUNCHING AND LANDING A DRONE FROM THE INTERIOR OF A VEHICLE

(71) Applicant: Ford Global Technologies, LLC, Dearborn, MI (US)

(72) Inventors: Brendan Diamond, Grosse Pointe, MI (US); Keith Weston, Canton, MI (US); Michael Alan Mcnees, Flat Rock, MI (US); Andrew Denis Lewandowski, Sterling Heights, MI (US); Jordan Barrett, Milford, MI (US)

(73) Assignee: Ford Global Technologies, LLC, Dearborn, MI (US)

(21) Appl. No.: 18/154,808

(22) Filed: Jan. 14, 2023

(51) Int. Cl. B64U 70/93; B60P 3/11; B60W 40/06; B60W 40/10; B64C 39/02; G05D 1/10

(52) U.S. Cl. CPC B64U 70/93; B60P 3/11; B60W 40/06; B60W 40/10; B64C 39/024; G05D 1/101; B60W 2520/00; B60W 2552/20; B60W 2554/00

(57) ABSTRACT

Systems and methods for implementing an automotive drone deployment system. The automotive drone deployment system may comprise at least a vehicle and a deployable drone. The vehicle may have an interior sensor suite and a plurality of potential exit points for the deployable drone. Objects and occupants of the vehicle may be retained when calculating the plurality of potential exit points. A route may be selected from the plurality of potential exit points. The vehicle may provide the drone with trajectory commands to control the path of the drone. The commands may be received by the drone and realized via the drone-based control system.

### BACKGROUND

There are many benefits of using autonomous drones in conjunction with a vehicle. Due to the sensors they carry, maneuverability, range, versatility, and much more, drones are becoming more and more commonly integrated with existing vehicle systems for off-road activities, people monitoring, and much more commonly being integrated with existing vehicle systems for off-road activities, people monitoring, and so on and so forth. Additionally, many drones have cameras, sensors, and object recognition features that can be helpful to a vehicle in transit.

While some techniques for drone-vehicle integration are known, these typically focus on launching the drone from the exterior of the vehicle or specific openings (e.g., a moonroof) and typically focus on the vehicle being stationary when the drone is being launched. Drawbacks in drone deployment systems mean that vehicles may be need to be specially designed or modified for use with drones—for example, an exterior landing pad may need to be installed on a vehicle. There is, therefore, a present need to address the aforementioned drawbacks and provide for enhancements to drone-vehicle integration.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a diagram comprising at least an aerial drone vehicle and an aerial drone, according to at least one embodiment of the present disclosure.

FIG. 2 illustrates a diagram in which techniques for determining suitable flight paths for launching a drone from the interior of a vehicle, according to at least one embodiment of the present disclosure.

FIG. 3 illustrates a diagram in which an aerial drone may be launched while a vehicle is in motion, according to at least one embodiment.

FIG. 4 shows an illustrative example of a process for launching an aerial drone from the interior of a vehicle, in accordance with one or more example embodiments of the present disclosure.

FIG. 5 shows an illustrative example of a process for landing an aerial drone in the interior of a vehicle, in accordance with one or more example embodiments of the present disclosure.

### DETAILED DESCRIPTION

### Overview

The present disclosure is directed to systems and methods for launching and landing an autonomous drone from the interior of a vehicle. As described in greater detail below, a vehicle may comprise an interior sensor suite. Sensor data from the interior sensor suite, drone information, and connected vehicle data may be utilized to determine a manner in which to launch a drone from the interior of a vehicle and/or return to the interior of the vehicle. Within the state of the art, automotive drone deployment systems are known. In an automotive drone deployment system, a deployable drone can be configured to attach and detach from the vehicle and, more specifically, the vehicle and drone remain in communication with each other to exchange information while the vehicle is being operated in an autonomous driving mode so that the vehicle's performance under the autonomous driving mode is enhanced.

According to one aspect of the present disclosure, a vehicle controls body closures to facilitate launching of a drone from the interior of a vehicle and/or landing the drone in the interior of the vehicle. The vehicle may determine a plurality of potential exits from the vehicle for a drone that is situated in the interior of the vehicle. Based on clearance of the drone to the exit location, occupant location, and obstacles within the interior of the vehicle, a suitable trajectory may be determined for the drone. If needed, the vehicle can control body closures and interior elements to facilitate the trajectory of the drone. For example, the vehicle may move, rotate, or fold seats automatically to allow for increased clearance between the drone and vehicle.

Techniques described herein relate to determining when it is desirable and not desirable to launch a drone from the interior of a vehicle. The vehicle may use an interior sensor suite of cameras and sensors to ensure there are no objects around the exit location of the drone and to ensure the drone can adequately bypass all objects as it exits the vehicle. If a passenger or other individual is located within the vehicle, the calculated flight trajectory may take into account the location and orientation of such individuals. For example, an additional amount of clearance may be provided when navigating around or in the vicinity of the occupants of the vehicle.

Techniques described herein relate to vehicle interior drone launch and return planning. In various embodiments, a plurality of potential exits of a vehicle may be identified. These potential exits may include windows, doors, rear hatches, moonroofs, and other potential flight paths for a drone in the interior of a vehicle to exit the vehicle or return to the vehicle. A vehicle's interior cameras/sensors, exterior cameras/sensors, drone information, etc. may be utilized to determine an interior pathfinding algorithm for a launch path and/or return path for the drone when the vehicle is motion or from a stopped position using.

This functionality may be implemented at least in part by drone specifications being provided to the vehicle regarding the size, propeller location, propeller diameter, and current location of the drone within the vehicle. In various embodiments, the drone specifications are determined by interior sensors/cameras of the vehicle. In some embodiments, the drone is able to transmit drone specification information to the vehicle to provide the vehicle with detailed information regarding the size, propeller diameter, clearance requirements, or other information that may be used to determine a flight path for the vehicle out of or into a vehicle.

A flight path may be determined in the following manner: the vehicle will identify potential exits from the vehicle. In various embodiments, all potential exits of the vehicle are identified; in some cases only the top N (e.g., top 3) are identified based on various criteria such as clearance of the drone to the exit location, occupant location, and obstacles within the vehicle that could result in altering the trajectory of the drone as it leaves the vehicle. In some embodiments, the vehicle will move, rotate, or fold seats automatically to allow for increased clearance between the drone and vehicle to create a suitable flight path. In various embodiments, path creation and drone routing can be completed using A* pathfinding algorithms which can be used to bypass obstacles while providing the simplest and/or easiest route out of the vehicle. In various embodiments, a plurality of potential exit paths are calculated and ranked to determine a most suitable exit path.

Certain restrictions can be enforced based on the control fidelity of the drone such that it cannot travel within a predetermined distance of a person, it can only be launched below a threshold vehicle speed of X mph, if travelling, it can only be launched out of windows, doors, rear hatches, etc. can only be moved while the vehicle is stationary, and so on and so forth.

In various embodiments, if no path is available for the drone to launch with sufficient clearance, the vehicle will inform the requestor that no path can be created and the launch will be delayed or canceled. The vehicle can also provide reasons as to why a launch will not occur, for example, a central HMI console of the vehicle may present a graphical interface indicating a launch is delayed or canceled. If the vehicle senses people are within a predetermined distance to the vehicle, it can determine to not launch the drone or delay the launch and wait to open the closure until the person is farther away from the vehicle. The vehicle can also provide reasons as to why a launch will not occur, for example, a central HMI console of the vehicle may present a graphical interface indicating a launch is delayed or canceled.

In various embodiments, once the vehicle has determined that the interior and/or exterior of the vehicle is clear, the vehicle may launch the drone and monitor trajectory from the prescribed path using the interior vehicle camera and the drone sensors. The vehicle will open/close doors and windows as needed to allow the drone to leave the vehicle. If a person or object enters the desired path of the drone, the drone will be returned to the initial starting location or automatically drop to the ground to remove the potential for person/drone contact, according to various embodiments.

A drone may be linked to a vehicle's control system such that the vehicle can control the acceleration, speed, position, route, etc. of the drone relative to the vehicle. Various characteristics or functionality of the drone may be controlled by the vehicle. In various embodiments, the vehicle link with the sensor feeds of the drone to allow the vehicle to perform post processing/object detection/etc. based on a raw video feed provided by the drone.

In various embodiments, the vehicle is in communication with the drone and provides trajectory commands to control the path of the drone. The commands may control the direction and/or speed of the drone. The commands may be received by the drone and realized via the drone-based control system.

According to various aspects of the present disclosure, the drone is launched from a moving vehicle. As the vehicle moves, accelerates, decelerates, etc. the vehicle will create the corresponding command to the drone to ensure the vehicle and drone are in the same velocity reference frame.

While various techniques described above and below describe launching of a drone and planning for the launching of a drone, it should be appreciated that the techniques discussed in connecting with launching a drone may based on the context, be applicable or adaptable for returning or landing a drone within the interior of a vehicle. For example, when the drone is ready to return to the vehicle, the drone will communicate intent to land, the vehicle will provide a return path including an entry location. Once the drone is next to the vehicle, the closure will open and the drone will be able to return to the vehicle.

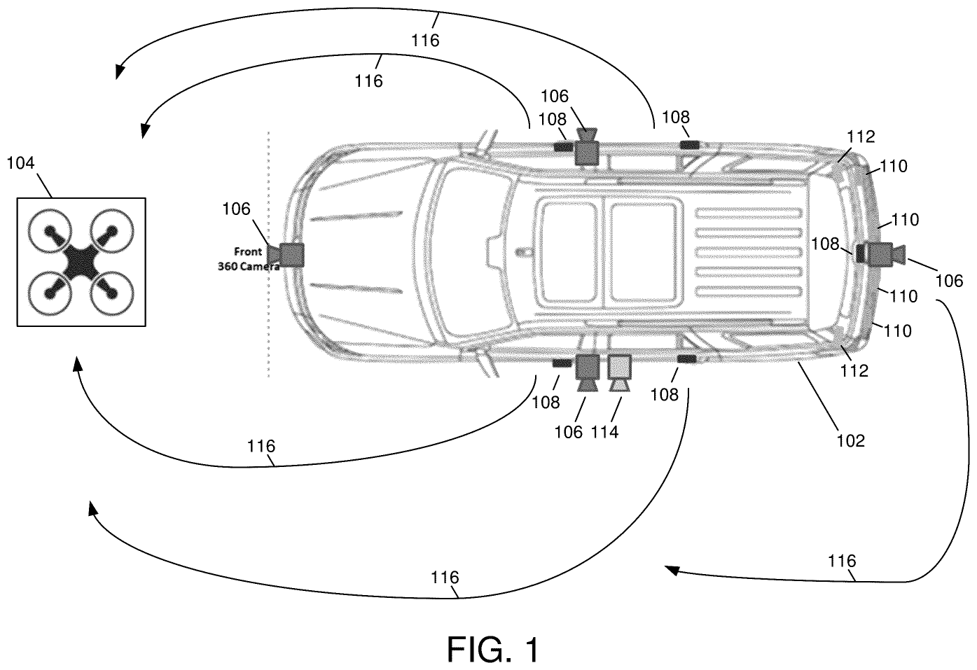

FIG. 1 illustrates a diagram 100 in which techniques for launching and landing an aerial drone may be practiced, according to at least one embodiment.

FIG. 1 depicts a diagram 100 illustrating vehicle 102 and an aerial drone 104. The aerial drone 104 may be launched from the interior of vehicle 102 using techniques described in this disclosure. According to at least one embodiment, the autonomous drone may be launched while the vehicle is in motion.

The vehicle 102 may comprise a suite of sensors. The sensors may comprise interior suite of sensors/cameras for monitoring and determining a flight path for the drone 104 through the interior of the vehicle. The sensors may comprise exterior suite of sensors/cameras for monitoring and determining the flight path of the drone 104 through the exterior of the vehicle. The sensors may include, for example, cameras 106 may provide a 360 degrees view around the vehicle that can be used to detect obstructions around the exterior of the vehicle that may block a drone's flight path. For example, if another vehicle is adjacent to the vehicle on either its left or right side, there may be insufficient clearance for a drone to be launched from that side of the vehicle. The sensors may include, for example, radar sensor(s) 108, ultrasonic sensors 110, Blind Spot Information System (BLIS) sensor(s) 112, facial recognition camera(s) 114, and so on and so forth.

The sensors and vision systems described with reference to the vehicle 102 in FIG. 1 may include, but are not limited to, digital/analog cameras, digital/analog video cameras, infrared (IR) sensors, ultrasonic proximity sensors, electromagnetic sensors, Lidar sensors (or other similar spinning range sensor) and other similar types of sensors that may be placed on the vehicle for detecting objects that may surround the vehicle as well as environmental conditions near the vehicle. The vehicle 102 may also include additional vehicle sensors to obtain information on various vehicle attributes and external conditions such as, but not limited to, temperature sensors for measuring a temperature of various vehicle components and/or interior conditions and/or exterior conditions, speed sensors for measuring the traveling speed of the vehicle 102, positioning sensors (e.g., GPS) for identifying a location of the vehicle 102, and other similar types of sensors for obtaining vehicle attribute and/or vehicle state information.

It should be noted that the sensors and systems described as being included on the vehicle 102 are provided for exemplary purposes only, as it is within the scope of this disclosure for the vehicle 102 to include a fewer, or greater, number of such sensors and/or systems for obtaining information that may be utilized during the operation of the vehicle 102 in the autonomous mode and/or during an operation of the vehicle that involves a drone component. Further, each of the sensors illustrated in FIG. 1 may be representative of a system of one or more sensors.

According to at least one embodiment of the present disclosure, a vehicle 102 comprises a suite of interior cameras. Video from the interior cameras may be used in association with artificial intelligence (AI) and/or machine learning (ML) algorithms can also be used to perform object detection (e.g., to identify various objects that may obstruct a flight path), object classification (e.g., to identify the location of humans within the vehicle and ensure that flight paths provide a greater clearance to bypass disturbing or startling occupants), object tracking (e.g., tracking the movement or reactions of individuals as a drone is launched or is landing nearby), and so on and so forth.

In various embodiment, a request to launch a drone 104 is realized. The launch request may be initiated from within the vehicle 102, for example, through a human machine interface (HMI) such as a central control console that the user may be use to initiate or confirm a drone launch. As a second example, the request may be initiated by a mobile device or smartphone of a user within the vehicle 102 that is paired with the vehicle (e.g., using a wireless Bluetooth or Wi-Fi connection).

In some embodiments, a request to launch a drone 104 is performed remotely. For example, the vehicle 102 may be connected to various services that may initiate a launch request for a variety of reasons or purposes. In one such example, if the vehicle 102 is connected to a traffic or navigation service, the service may have information regarding a recent accident or traffic slowdown ahead of the vehicle. A request to launch a drone 104 may be initiated remotely for the drone 104 to fly ahead to the predicted or most probable path of the vehicle 102 and collect up-to-date traffic conditions, search for alternative routes, and so on and so forth. A remote request may be transmitted to the vehicle and require confirmation by the driver or other occupant of the vehicle prior to proceeding with the launch of the drone 104.

In some embodiments, a remote request is transmitted to the vehicle 102 by another vehicle via vehicle-to-vehicle (V2V) communications. For example, V2V communications may be transmitted by a first vehicle to a second vehicle to identify a point of interest. For example, on a safari or sightseeing tour, a first vehicle may transmit geolocation information of wild animals, a pod of Orca whales, etc. When a point of interest (POI) is identified by a first vehicle (e.g., occupants thereof or sensors) the first vehicle may broadcast information regarding the point of interest to other nearby vehicles, such as the topic or subject of the POI, the location of the POI, the heading or direction of the POI, and so on and so forth. A drone may be deployed from a second vehicle to track a mobile POI, to take pictures or video, or otherwise perform other actions that may be desirable for a second vehicle with drone launching capabilities.

A drone 104 may be linked to a vehicle's control system such that the vehicle 102 can control the acceleration, speed, position, route, etc. of the drone relative to the vehicle 102. Various characteristics or functionality of the drone 104 may be controlled by the vehicle 102. In various embodiments, the vehicle 102 links with the sensor feeds of the drone 104 to allow the vehicle to perform post processing/object detection/etc. based on a raw video feed provided by the drone 104.

In various embodiments, the vehicle 102 is in communication with the drone 104 and provides trajectory commands to control the path of the drone 104. The commands may control the direction and/or speed of the drone 104. The commands may be received by the drone 104 and realized via the drone-based control system.

In various embodiments, the drone 104 is launched from a moving vehicle 102. As the vehicle 102 moves, accelerates, decelerates, etc. the vehicle 102 will create the corresponding command to the drone 104 to ensure the vehicle and drone are in the same (or constant) velocity reference frame.

A flight path may be determined in the following manner: the vehicle 102 will identify potential exits for the drone 104 from the vehicle 102. In various embodiments, all potential exits of the vehicle 102 are identified, in some cases only the top N (e.g., top 3) are identified based on various criteria such as clearance of the drone 104 to the exit location, occupant location, and obstacles within the vehicle that could result in altering the trajectory of the drone as it leaves the vehicle 102. In various embodiments, path creation and drone routing can be completed using A* pathfinding algorithms which can be used to bypass obstacles while providing the simplest and/or easiest route out of the vehicle. In various embodiments, a plurality of potential exit paths are calculated and ranked to determine a most suitable exit path for the drone 104.

In some embodiments, the vehicle 102 will move, rotate, or fold seats automatically to allow for increased clearance between the drone and vehicle to create a suitable flight path. The vehicle may automatically adjust one or more interior features of the vehicle to facilitate launching of the drone on a desired route, such as by moving, rotating, or folding one or more seats of the vehicle to allow for increased clearance.

Certain restrictions can be enforced based on the control fidelity of the drone 104 such that it cannot travel within a predetermined distance of a person, it can only be launched below a threshold vehicle speed of X mph, if travelling, it can only be launched out of windows, doors, rear hatches, etc. can only be moved while the vehicle is stationary, and so on and so forth.

In various embodiments, if no path is available for the drone 104 to launch, the vehicle 102 will inform the requestor that no path can be created and the launch will be delayed or canceled. The vehicle 102 can also provide reasons as to why a launch will not occur, for example, a central HMI console of the vehicle may present a graphical interface indicating a launch is delayed or canceled.

When the drone 104 is ready to return to the vehicle 102, the drone will communicate intent to land, the vehicle will provide a return path including an entry location. Once the drone is next to the vehicle, the closure will open and the drone will be able to return to the vehicle.

In various embodiments, the vehicle 102 uses connected vehicle data such as weather apps, Electronic Horizon (EH), Map Data, and GPS to provide the future trajectory (speed, acceleration/deceleration) of the vehicle to help route and/or guide the drone and ensure it staying in the same (or constant) relative velocity reference frame.

Weather applications can be used to provide wind direction and speed as well as recommendations for launch location or recommendations not to launch (snowy, rainy, etc.)

In various embodiments, REM/Roadbook or other digital datasets may provide information regarding expected road conditions ahead. Road conditions may also be determined using external sensor suite of cameras/radars to determine whether the road ahead contains potholes, undulations, or rough terrain. If poor road conditions are detected head, the drone launch may be delayed. Alternatively, if the road ahead is not the most probable, then focus the road image recognition on this new road.

In the event that the new road is not in the current field of view of the camera, incorporate REM/Roadbook data to determine the characteristics of the new road (# lanes, roughness, ideal speed, etc.) In various embodiments, vehicle-to-vehicle (V2V) and/or vehicle-to-everything (V2X) communications systems may be used to communicate between vehicles and share data/information on road surfaces.

In addition to the IPMA+MPP+REM/Roadbook integration, also look at the vehicle inertial measurement unit (IMU) data. An IMU may refer to a device that directly measures a vehicle's three linear acceleration components and three rotational rate components. The vehicle may revert to vehicle IMU data only when the above sensor inputs indicate no major rough obstacles ahead. Vehicle IMU data, particularly in the z direction, can be used to determine the roughness of the current road and determine whether a drone launch is possible. In various embodiments, exterior sensor suite (e.g., radar/cameras/LIDAR) may be used to scan the road for roughness in addition to or in place of IMU data. In either case, a drone launch may be possible, but this data (e.g., from IMU and/or exterior sensors) should be fed to the path planning algorithm for the drone to assist it in launching in a moderately rough environment.

In various embodiments, launching of a drone can be accommodated by utilizing chassis systems controls such as those used for live valve dampers on various vehicles. These systems utilize ride height sensors and accelerometers to vary damping. For example, the chassis control system may be used to vary suspension damping (shock technology), ride height (adaptive springs), spring rate (adaptive springs), roll couple (active roll bars) to stabilize vehicle and optimize drone launch conditions. In various embodiments, the launch of drones in conditions when chassis systems controls predict harsh terrain may be halted or canceled.

In various embodiments, machine learning can be utilized to determine areas where suspension/chassis systems are active and where road surface is smooth and confine drone operation/launch to areas where vehicle is stable.

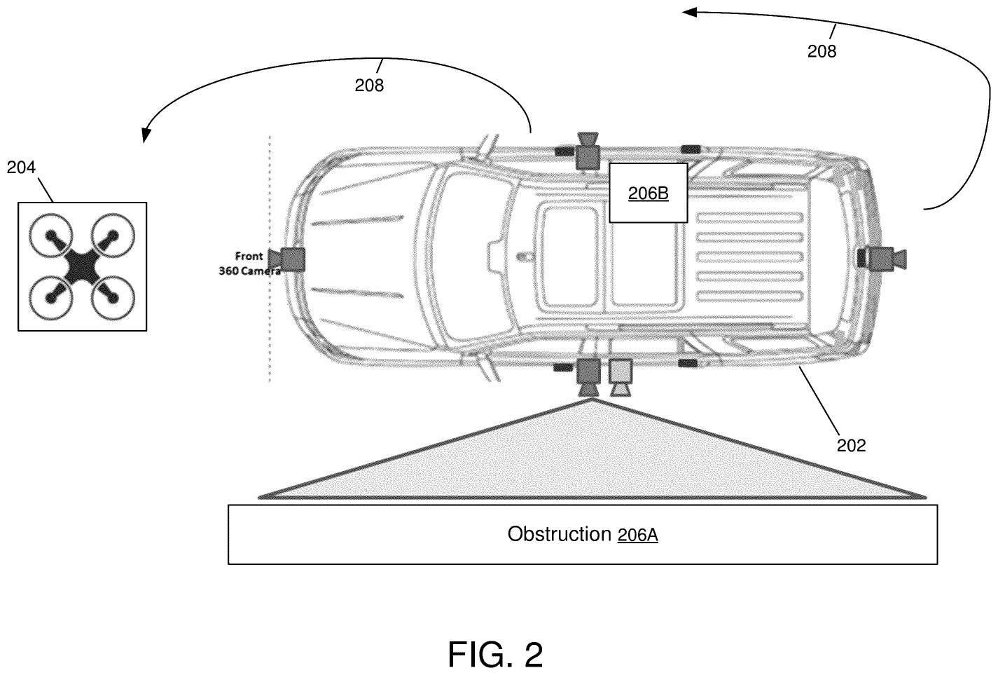

FIG. 2 illustrates a diagram 200 in which techniques for determining suitable flight paths for launching a drone 204 from the interior of a vehicle 202, according to at least one embodiment. The potential flight path 208 for the drone may be determined based on the presence of various obstructions, such as exterior obstruction 206A and interior obstruction 206B that may impede the launching and/or landing of the drone 204.

A vehicle 202 may comprise an exterior suite of sensors/cameras that are used to determine a suitable launching path for a drone 204. For example, the vehicle may use the radar to ensure there are no objects and/or people around the exit location of the drone and to ensure the drone can adequately bypass all objects and/or people as it exits the vehicle. For example, the vehicle 202 may comprise interior sensors/cameras to determine the location of objects and occupants of the vehicle. For example, interior obstruction 206B may refer to a passenger in the back of the vehicle 202, a large object that would impede takeoff or landing, etc. If the vehicle is operating a closure (door, liftgate, etc.), the vehicle can use exterior sensors such as ultrasonic sensors or radar to ensure the obstacles around the vehicle are far enough away from the closure to not disrupt the ability of the closure to be opened. For example, obstruction 206A may be close enough to vehicle 202 that there is not enough clearance to open a door and/or there is not enough airspace to launch drone 204 from that side of the vehicle 202.

If the vehicle 202 senses people are within a predetermined distance to the vehicle, it can determine to not launch the drone 204 or delay the launch and wait to open the closure until the person is farther away from the vehicle. The vehicle can also provide reasons as to why a launch will not occur, for example, a central HMI console of the vehicle may present a graphical interface indicating a launch is delayed or canceled.

In various embodiments, once the vehicle 202 has determined that the interior and/or exterior of the vehicle 202 is clear, the vehicle 202 may launch the drone 204 and monitor trajectory from the prescribed path using the interior vehicle camera and the drone sensors. The vehicle will open/close doors and windows as needed to allow the drone to leave the vehicle. If a person or object enters the desired path of the drone, the drone will be returned to the initial starting location or automatically drop to the ground to bypass the potential for person/drone contact, according to various embodiments.

Potential flight path 208 may be determined in the following manner: the vehicle 202 will identify potential exits for the drone 204 from the vehicle 202. In various embodiments, all potential exits of the vehicle are identified; in some cases only the top N (e.g., top 3) are identified based on various criteria such as clearance of the drone 204 to the exit location, occupant location, and obstacles within the vehicle that could result in altering the trajectory of the drone 204 as it leaves the vehicle 202. In some embodiments, the vehicle 202 will move, rotate, or fold seats automatically to allow for increased clearance between the drone 204 and vehicle 202 to create a suitable flight path. In various embodiments, path creation and drone routing can be completed using A* pathfinding algorithms which can be used to bypass obstacles while providing the simplest and/or easiest route out of the vehicle. In various embodiments, a plurality of potential exit paths are calculated and ranked to determine a most suitable exit path.

DAT features calculations such as proximity to other vehicles can be used to prevent drone launch if it indicates the launch vehicle is too close to another vehicle and an unexpected acceleration/deceleration event could occur. In various embodiments, V2V and/or V2X communications may be used to share information regarding the proximity of nearby obstructions that may prevent the launch of a drone from a particular direction.

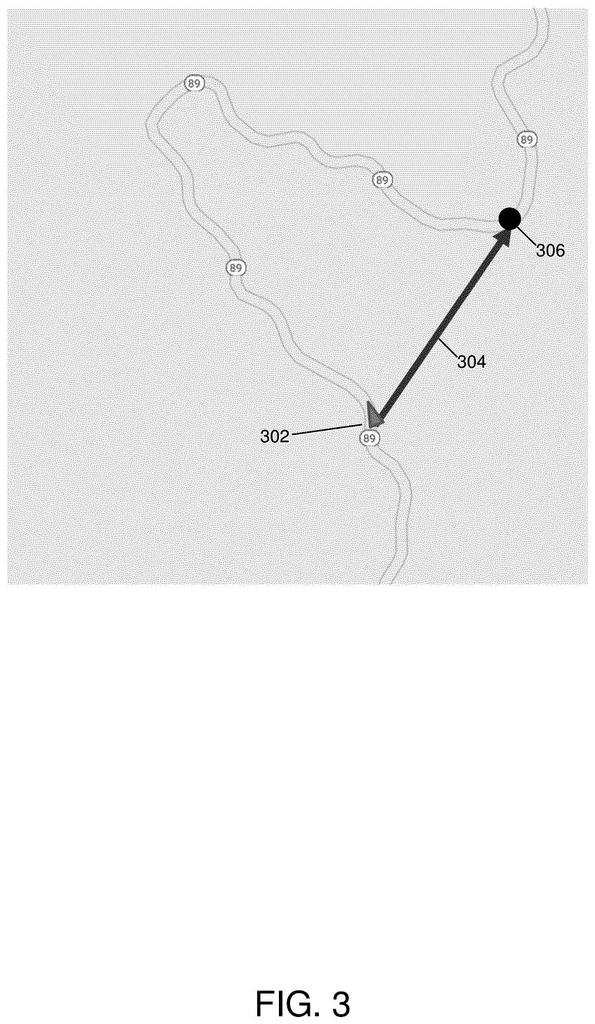

FIG. 3 illustrates a diagram 300 in which an aerial drone may be launched while a vehicle is in motion, according to at least one embodiment.

As depicted in FIG. 3, a vehicle may be traversing along a vehicle route 302 and may launch a drone while in motion. A drone route 304 may be computed so that the drone may reach a particular location 306 before the vehicle reaches the location 306. For example, the location 306 may be a blind spot, tight turn, location where traffic or road conditions (e.g., debris) has previously been detected.

Path of drone may differ from vehicle, as depicted in FIG. 3. FIG. 3 depicts a scenario in which a vehicle route 302 follows a winding road whereas a drone route 304 may be a direct, shorter path that may be used by the drone to reach a particular destination, point of interest (POI), or other location 306 faster. Accordingly, it may be advantageous for a drone to take a shorter path over land as opposed to following a curved road. By taking the shorter, more direct path, the drone may save energy and provide for prolonged use of the drone.

In various embodiments, the drone may reach location 306 and transmit video or image footage to the vehicle, or provide additional driving information that might not otherwise be available to the vehicle. For example, a drone may reach location 306 and determine that there is a road condition (e.g., debris in the road, wildlife crossing the road, etc.) and alert the vehicle to the condition. The alert may include, for example, a live video feed, an image, or a message indicating to proceed with caution, for example.

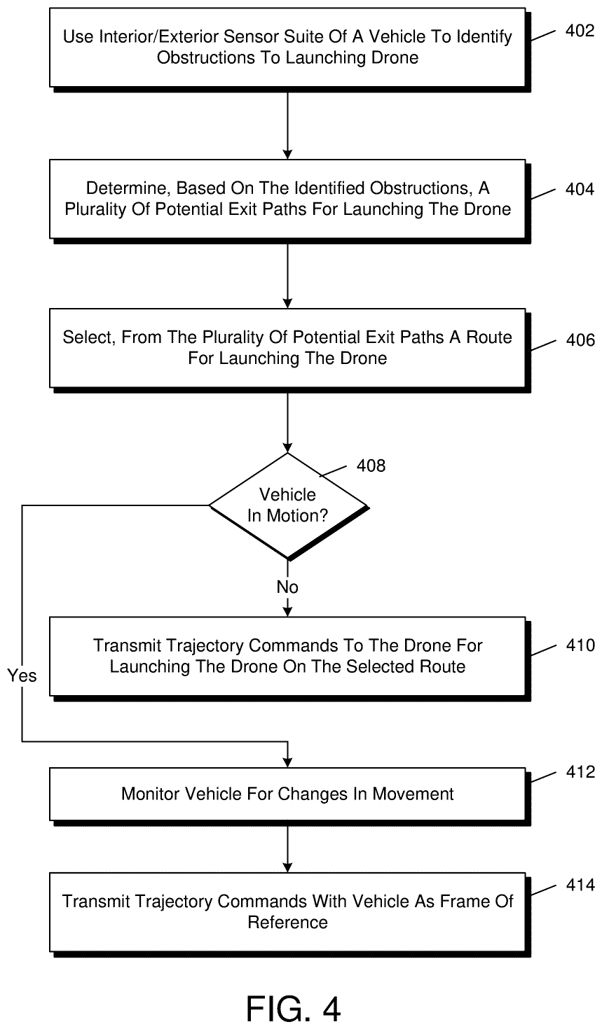

FIG. 4 shows an illustrative example of a process 400 for launching an aerial drone from the interior of a vehicle, in accordance with one or more example embodiments of the present disclosure. In at least one embodiment, some or all of the process 400 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. In various embodiments, the computer-executable instructions are loaded on an electronic system of a vehicle that locally performs various methods, routines, and processes described in connection with process 400. In some embodiments, the computer-executable instructions are executed on a remote system (e.g., remote server) that the vehicle communications with over a network connection. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 400 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 400 may be implemented in the context of various systems and methods described elsewhere in this disclosure, such as those discussed in connection with FIGS. 1-3. Process 400 may be performed by a control unit of a vehicle implemented in the context of FIG. 1, for example.

In at least one embodiment, process 400 comprises a step 402 to use interior and/or exterior sensor suite of a vehicle to identify obstructions to launching a drone. The sensors and vision systems used to identify obstructions may include, but are not limited to, digital/analog cameras, digital/analog video cameras, infrared (IR) sensors, ultrasonic proximity sensors, electromagnetic sensors, Lidar sensors (or other similar spinning range sensor) and other similar types of sensors that may be placed on the vehicle for detecting objects that may surround the vehicle as well as environmental conditions near the vehicle. The vehicle may also include additional vehicle sensors to obtain information on various vehicle attributes and external conditions such as, but not limited to, temperature sensors for measuring a temperature of various vehicle components and/or interior conditions and/or exterior conditions, speed sensors for measuring the traveling speed of the vehicle, positioning sensors (e.g., GPS) for identifying a location of the vehicle, and other similar types of sensors for obtaining vehicle attribute and/or vehicle state information.

In at least one embodiment, process 400 comprises a step 404 to determine, based on the identified obstructions, a plurality of potential flight paths for launching the drone. A potential flight path may be determined in the following manner: the vehicle will identify potential exits for the drone from the vehicle. In various embodiments, all potential exits of the vehicle are identified, in some cases only the top N (e.g., top 3) are identified based on various criteria such as clearance of the drone to the exit location, occupant location, and obstacles within the vehicle that could result in altering the trajectory of the drone as it leaves the vehicle. In some embodiments, the vehicle will move, rotate, or fold seats automatically to allow for increased clearance between the drone and vehicle to create a suitable flight path. In various embodiments, path creation and drone routing can be completed using A* pathfinding algorithms which can be used to bypass obstacles while providing the simplest and/or easiest route out of the vehicle.

In at least one embodiment, process 400 comprises a step 406 to select, from the plurality of potential exit paths, a route for launching the drone. In various embodiments, a plurality of potential exit paths are calculated and ranked to determine a most suitable exit path for the drone. The route may be chosen in any suitable manner. For example, the route may be chosen so as to dodge occupants of the vehicle such that given otherwise similar two paths, the path that is farther from occupants of the vehicle is preferred.

In at least one embodiment, process 400 comprises a step 408 to determine whether the vehicle is in motion. If the vehicle is not in motion, trajectory commands may be provided as per step 410; if the vehicle is in motion, the process 400 may further monitor the vehicle for changes in motion to maintain the vehicle as a frame of reference for the drone.

In at least one embodiment, process 400 comprises a step 410 to transmit trajectory commands to the drone for launching the drone on the selected route. If needed, the vehicle can control body closures and interior elements to facilitate the trajectory of the drone. For example, the vehicle may move, rotate, or fold seats automatically to allow for increased clearance between the drone and vehicle. In various embodiments, the vehicle is in communication with the drone and provides trajectory commands to control the path of the drone. The commands may control the direction and/or speed of the drone. The commands may be received by the drone and realized via the drone-based control system.

In at least one embodiment, process 400 comprises a step 412 to monitor vehicle for changes in motion. The changes may refer to acceleration or deceleration of the vehicle, turns, braking, movement along the z-axis due to potholes or road bumps, and so on and so forth. The vehicle's frame of reference may be established using such vehicle information.

In at least one embodiment, process 400 comprises a step 414 to transmit the trajectory commands to the drone with the vehicle as frame of reference. When the drone is launched from a moving vehicle, the vehicle will create the corresponding command to the drone to ensure the vehicle and drone are in the same (or constant) velocity reference frame as the vehicle moves, accelerates, decelerates, etc.

According to at least one embodiment, the autonomous drone may be launched while the vehicle is in motion—for example, the vehicle may be launched based on navigation data. For example, when the drone is within range of a particular point of interest, the drone may be launched. The point of interest may be a sharp turn, a traffic congested area, and so on and so forth.

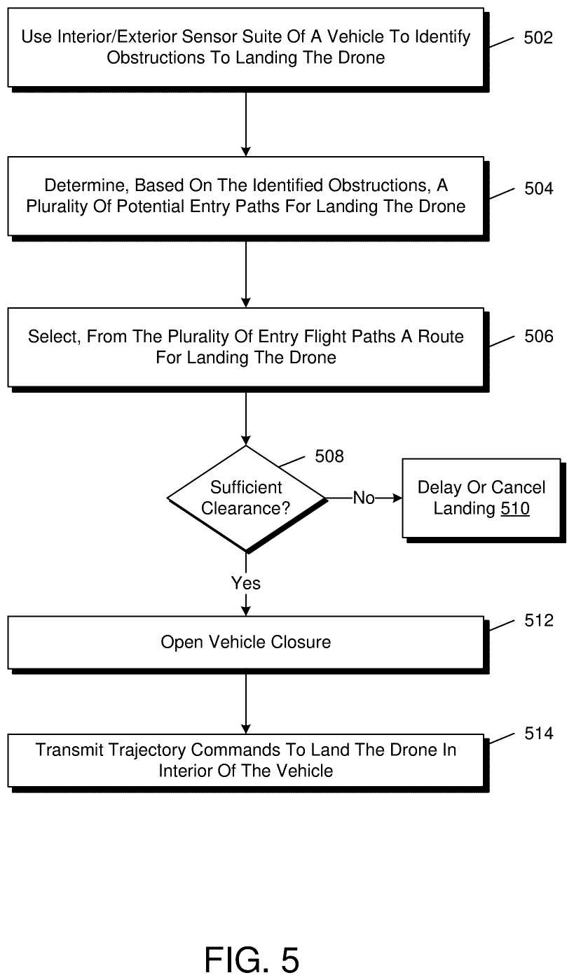

FIG. 5 shows an illustrative example of a process 500 for landing an aerial drone in the interior of a vehicle, in accordance with one or more example embodiments of the present disclosure. In at least one embodiment, some or all of the process 500 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. In various embodiments, the computer-executable instructions are loaded on an electronic system of a vehicle that locally performs various methods, routines, and processes described in connection with process 500. In some embodiments, the computer-executable instructions are executed on a remote system (e.g., remote server) that the vehicle communications with over a network connection. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 500 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 500 may be implemented in the context of various systems and methods described elsewhere in this disclosure, such as those discussed in connection with FIGS. 1-3. Process 500 may be performed by a control unit of a vehicle implemented in the context of FIG. 1, for example.

In at least one embodiment, process 500 comprises a step 502 to use interior/exterior sensors suite of a vehicle to identify obstructions to landing the drone. The sensors and vision systems used to identify obstructions may include, but are not limited to, digital/analog cameras, digital/analog video cameras, infrared (IR) sensors, ultrasonic proximity sensors, electromagnetic sensors, Lidar sensors (or other similar spinning range sensor) and other similar types of sensors that may be placed on the vehicle for detecting objects that may surround the vehicle as well as environmental conditions near the vehicle. The vehicle may also include additional vehicle sensors to obtain information on various vehicle attributes and external conditions such as, but not limited to, temperature sensors for measuring a temperature of various vehicle components and/or interior conditions and/or exterior conditions, speed sensors for measuring the traveling speed of the vehicle, positioning sensors (e.g., GPS) for identifying a location of the vehicle, and other similar types of sensors for obtaining vehicle attribute and/or vehicle state information.

In at least one embodiment, process 500 comprises a step 504 to determine, based on the identified obstructions, a plurality of potential entry paths for landing the drone. A potential flight path for landing the drone may be determined in the following manner: the vehicle will identify potential entries for the drone from the vehicle. In various embodiments, all potential entries of the vehicle are identified, in some cases only the top N (e.g., top 3) are identified based on various criteria such as clearance of the drone to the entry location, occupant location, and obstacles within the vehicle that could result in altering the trajectory of the drone as it enters the vehicle. In some embodiments, the vehicle will move, rotate, or fold seats automatically to allow for increased clearance between the drone and vehicle to create a suitable flight path. In various embodiments, path creation and drone routing can be completed using A* pathfinding algorithms which can be used to bypass obstacles while providing the simplest and/or easiest route into the vehicle.

In at least one embodiment, process 500 comprises a step 506 to select, from the plurality of potential entry paths, a route for landing the drone. In various embodiments, a plurality of potential exit paths are calculated and ranked to determine a most suitable exit path.

In at least one embodiment, process 500 comprises a step 508 to determine whether there is sufficient clearance for landing the drone. The clearance may be required to open a door, rear hatch, or other vehicle enclosures. In some cases, this step may be optional or considered always met, such as if the entry point for a drone is a moonroof or window in which case there is no additional clearance needed to open the enclosure. If there is not sufficient clearance, the process 500 may proceed to step 510 and either delay or cancel the landing.

In at least one embodiment, process 500 comprises a step 512 to open the closure (door, liftgate, etc.). The closure may be identified from the landing route. In some cases, this step may be optional or considered always met, such as if the entry point for a drone is a moonroof or window in which case there is no additional clearance needed to open the enclosure. If there is not sufficient clearance, the process 500 may proceed to step 510 and either delay or cancel the landing.

In at least one embodiment, process 500 comprises a step 514 transmit trajectory commands to land the drone in the interior of the vehicle. In various embodiments, flight commands are transmitted continuously through operation of the drone. When the enclosure is opened, the drone may receive trajectory commands to enter to interior of the vehicle and land at a designated spot within the vehicle.

The vehicle may further be comprised of system input components that include, but are not limited to, radar sensor(s), infrared sensor(s), ultrasonic sensor(s), camera (e.g., capable of capturing digital still images, streaming video, and digital video), and vehicle sensor(s) (e.g., temperature sensors, fluid level sensors, vehicle speed detection sensors, etc.). The drone operational tool may receive information inputs from one or more of these system input components. The input components are in communication with the processing unit via a communications bus.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method for launching a drone from an interior of a vehicle, comprising:
using, by one or more processors of the vehicle, a plurality of sensors of the vehicle to identify one or more obstructions to launching the drone from the interior of the vehicle;
determining, by the one or more processors of the vehicle and based on the one or more obstructions, a plurality of potential exit paths for launching the drone, wherein the plurality of potential exit paths bypass the one or more obstructions;
selecting, by the one or more processors of the vehicle, from the plurality of potential exit paths, a route for launching the drone from the interior of the vehicle;
determining, by the one or more processors of the vehicle and based on the selected route, first trajectory commands for launching the drone; and
transmitting, by the one or more processors of the vehicle, the first trajectory commands to the drone.

2. The method of claim 1, further comprising:
monitoring, by the one or more processors of the vehicle, movement of the vehicle while the drone is being launched from the interior of the vehicle;
detecting, by the one or more processors of the vehicle, a change in acceleration or deceleration of the vehicle;
responsive to the change, determining, by the one or more processors of the vehicle, second trajectory commands for the drone to maintaining a constant velocity reference frame; and
transmitting, by the one or more processors of the vehicle, the second trajectory commands to the drone.

3. The method of claim 1, wherein the selecting of the route from the plurality of potential exit paths, comprises selecting a potential exit path of the plurality of potential exit paths that bypass occupants of the vehicle.

4. The method of claim 1, further comprising opening a closure of the vehicle.

5. The method of claim 1, further comprising:
determining, using a vehicle inertial measurement unit (IMU) of the vehicle and one or more exterior sensors of the plurality of sensors, expected roughness of a road being traversed by the vehicle; and
delaying launching of the drone responsive to the expected roughness of the road.

6. The method of claim 1, further comprising adjusting one or more interior features of the vehicle to facilitate launching of the drone on the route.

7. The method of claim 6, wherein the adjusting comprises moving, rotating, or folding one or more seats of the vehicle to allow for increased clearance.

8. A vehicle, comprising:
a plurality of sensors;
a plurality of closures;
a control unit comprising one or more processors and memory storing executable instructions that, as a result of execution by the one or more processors, cause the one or more processors to:
identify, using the plurality of sensors, one or more obstructions to launching a drone from an interior of the vehicle;
determine, based on the one or more obstructions, a plurality of potential exit paths for launching the drone, wherein the plurality of potential exit paths bypass the one or more obstructions;
select, from the plurality of potential exit paths, a route for launching the drone;
determine, based on the selected route, first trajectory commands for launching the drone; and
transmit the first trajectory commands to the drone.

9. The vehicle of claim 8, wherein the one or more processors are configured to cause the vehicle to:
monitor movement of the vehicle while the drone is being launched from the interior of the vehicle;
detect a change in acceleration or deceleration of the vehicle;
responsive to the change, determine second trajectory commands for the drone to maintaining a constant velocity reference frame; and
transmit the second trajectory commands to the drone.

10. The vehicle of claim 8, wherein the plurality of sensors comprises a plurality of interior sensors for identifying interior obstructions and a plurality of exterior sensors for identifying exterior obstructions.

11. The vehicle of claim 8, wherein the one or more processors are configured to cause the vehicle to open a closure of the plurality of closures that allows the drone to exit the vehicle along the route.

12. The vehicle of claim 8, wherein:
the vehicle further comprises a vehicle inertial measurement unit (IMU) of the vehicle;
the plurality of sensors comprises one or more exterior sensors/cameras; and
the control unit is further configured to:
determine expected roughness of a road being traversed by the vehicle based on data collected from the vehicle IMU, the one or more exterior sensors/cameras, or a combination thereof; and
delay launching of the drone responsive to the expected roughness of the road.

13. The vehicle of claim 8, wherein the one or more processors are configured to cause the vehicle to adjust one or more interior features of the vehicle to facilitate launching of the drone on the route.

14. The vehicle of claim 13, wherein the adjustment is one of moving, rotating, or folding one or more seats of the vehicle to allow for increased clearance.

15. A method for landing a drone in an interior of a vehicle, comprising:
using, by one or more processors of the vehicle, a plurality of sensors of the vehicle to identify one or more obstructions to landing the drone in the interior of the vehicle;
determining, by the one or more processors of the vehicle and based on the one or more obstructions, a plurality of potential entry paths for launching the drone, wherein the plurality of potential entry paths bypass the one or more obstructions;
selecting, by the one or more processors of the vehicle, from the plurality of potential entry paths, a route for landing the drone in the interior of the vehicle;
determining, by the one or more processors of the vehicle and based on the selected route, first trajectory commands for landing the drone; and
transmitting, by the one or more processors of the vehicle, the first trajectory commands to the drone.

16. The method of claim 15, further comprising:
determining by the one or more processors of the vehicle, the drone has entered the vehicle; and
responsive to determining the drone is in the interior of the vehicle:
monitoring, by the one or more processors of the vehicle, movement of the vehicle while the drone is landing;
detecting, by the one or more processors of the vehicle, a change in acceleration or deceleration of the vehicle;
responsive to the change, determining, by the one or more processors of the vehicle, second trajectory commands for the drone to maintaining a constant velocity reference frame; and
transmitting, by the one or more processors of the vehicle, the second trajectory commands to the drone.

17. The method of claim 15, wherein the selecting of the route from the plurality of potential entry paths, comprises selecting a potential entry path of the plurality of potential entry paths that bypass occupants of the vehicle.

18. The method of claim 15, further comprising opening a closure of the vehicle.

19. The method of claim 15, further comprising:
determining, using a vehicle inertial measurement unit (IMU) of the vehicle and one or more exterior sensors of the plurality of sensors, expected roughness of a road being traversed by the vehicle; and
delaying landing of the drone responsive to the expected roughness of the road.

20. The method of claim 15, further comprising adjusting one or more interior features of the vehicle to facilitate landing of the drone in the interior of the vehicle.
